(19) United States
(12) Patent Application Publication
(10) Pub. No.: US 2015/0127673 A1
(43) Pub. Date: May 7, 2015

(54) Method and system for searching visually similar goods in e-commerce web-sites

(71) Applicant: "Kuznetch" Ltd., Saint-Petersburg (RU)

(72) Inventors: Mikhail Lvovich Pogrebnyak, Saint-Petersburg (RU); Pavel Alexandrovich Cherkashin, Moscow (RU); Alexander Vladimirovich Valencia-Campo, Moscow (RU)

(73) Assignee: "KUZNETCH" LTD., Saint-Petersburg (RU)

(21) Appl. No.: 13/778,156

(22) PCT Filed: Aug. 9, 2012
(86) PCT No.: PCT/RU12/00651

§ 371 Date: Feb. 27, 2013

(30) Foreign Application Priority Data
Jul. 2, 2012 (RU) 2012127377

(51) Int. Cl. G06F 17/30; G06K 9/62

(52) U.S. Cl. CPC G06F 17/30247; G06F 17/30386; G06K 9/6202
USPC 707/758

(57) ABSTRACT

The present invention is related to methods for searching visually similar images and may be used in computer systems and mobile devices. The present invention allows the speed of searching for visually similar objects to be significantly increased. The present method can be applied in search engines and e-commerce web sites.

This present method of searching for visually similar images comprising: computation of the images descriptors on physical or digital media; computation of the difference of the images descriptors and storing the computed results on physical or digital media; receiving a user's request comprising an image identifier; displaying the computed results of the difference of the descriptors corresponding to the image, the identifier of which was obtained from the user.

### FIELD OF THE INVENTION

The present invention relates to the methods for searching visually similar images and can be used on computer systems and mobile devices. The invention allows the speed of searching for visually similar objects to be significantly increased. The suggested method can be widely used in Internet search engines and e-commerce web sites.

### DESCRIPTION OF THE RELATED ART

The U.S. patent application No. 2011/0314031, entitled “Product category optimization for image similarity searching of image-based listings in a network-based publication system” (filing date: Mar. 28, 2011), is the closest in technical nature to the present invention. Similar systems and methods are rather widely used. With such an invention, the user can upload an image into the system and determine the most similar images to it.

The main disadvantage of the above mentioned method and system is the low speed of data processing. The user, after the request has been sent, should wait a long time for it to be processed and the results of the search to be displayed.

### SUMMARY OF THE INVENTION

The main aim of the present invention is to increase the effectiveness and speed of request processing when searching for visually similar images.

The method of searching for visually similar images, according to this invention, comprises four stages.

In the first stage, the images descriptors are computed. In the context of the present invention, the term “image descriptor” means a character or a set of characters, which correspond to the particular property of the image. One parameter of the image corresponds to one or more descriptors. For example, if an image is of a circle, the descriptor of the “shape” parameter is equal to 100, if an image comprises a square; the description of the “shape” parameter is equal to 029, etc. The descriptor computation rules, quantity of the parameters for which the descriptors are computed and quantity of the descriptors corresponding to one parameter can be set by the person performing the search without a computer, or by a user of a system with the software, which implements the present invention, or by a software developer or its customer, or a third party. The image can be stored on data storage media.

In the second stage, the differences between the images descriptors are computed and the results are recorded on physical or digital media. If a search for visually similar images is performed without the use of hardware, it should be written on paper. The computation of descriptor difference depends on the number of descriptors corresponding to one parameter of the image, the number of image parameters and the method of computation. The method of computing descriptor difference may be specified by a user performing a search for visually similar images without a computer, a user of a system with software, which implements the present invention, a software developer, a customer of the software, or a third party. Typically, when using a computer or a device with a processor, a device for storing data and/or a database and a memory block comprising the program code which is executed by the processor and implements the present method of search for visually similar images, the result of one or more descriptor computations is stored in the device for storing data and/or in the database.

In the third stage, the query, inputted by the user, is received, comprising at least the image identifier. In the context of the present invention, the term “image identifier” means any identification (for example, number, sequence number, character, text, title, image descriptor, etc.) which identifies one or more images in the image-based listing. The user's request may additionally comprise a text message from the user, information about the configuration of the computer from which the request has been sent, information about the geographical location of the user, the serial number of the device or the serial number of the computer. The request can be transmitted orally, in writing or by technical means, for example a computer or device with software, which implements the present method for searching visually similar images. The request can be stored by any means, for example on paper, in a data storage device or in a database. If a computer or device with a processor, a device for storing data and/or a database, and a memory block comprising the program code, which is executed by the processor and implements the present method for searching visually similar images, is used, the user's request can be created without the user. In this case, the “user's request” means a message comprising at least the image identifier which was created by the computer or device automatically. The above mentioned computer or device can comprise, in some embodiments of the present invention, rules for automatic image selection and request creation, wherein the request comprises at least an image identifier. The rules may include an analysis of the system user's requests and a selection of the most popular image or images among other users, selected by the user in their previous session of working with the system.

In the fourth stage, the results of the computation of descriptor difference for the image, the identifier of which was obtained in the previous stage, are displayed. The clearest way of displaying the results of the descriptor difference computation for the user are in list form or in a two-dimensional matrix. The list can be sorted in order of decreasing value of descriptor difference or by increasing value of descriptor difference. The two-dimensional matrix of the results of the descriptor difference shows the results of the computed difference of descriptors in accordance with two main parameters. The main parameters and sorting schemes may be selected by the user, the developer of the software, which implements the present invention, the customer of the software, which implements the present invention, the customer of services for searching visually similar images or a third party. The clearest way of sorting for a user is sorting from the smallest computed result value of the descriptor difference upwards, from left to right and from top to the bottom. In such a case, the top left-hand corner of the matrix will show the most similar image to the image, which was selected by the user at the third stage, and the bottom right-hand corner will show the image with the least similarity. The rules determining the degree of image similarity may be set by the user performing a search according to this invention, the developer of the software to implement this method of searching for visually similar images, the customer of the software, which implements the present method for searching visually similar images, the customer of services for searching visually similar images or a third party.

The present method can be implemented on a device which comprises:

1. a processor;
2. a device for displaying data;
3. a device for storing data comprising at least one image;
4. a memory block functionally connected to the processor and comprising a code which, when executed by the processor, performs a search for visually similar images by:
   a. computing the images descriptors on the device for storing data;
   b. computing the difference between the images descriptors and storing the results to the device for storing data;
   c. receiving a user's request comprising the image identifier;
   d. displaying the results of the descriptor difference calculation corresponding to the image, the identifier of which was obtained from the user, on the device for displaying data.

The present method can be implemented in software. The applicable program in any eligible programming language is recorded in machine-readable form or a memory block (computer software product) for use with a computer to perform the above mentioned operations.

### DETAILED DESCRIPTION

The present invention can be implemented in different ways.

In one embodiment, the invention can be used without technical means such as a computer. In this embodiment, the image is stored on physical media. The user performing a search for visually similar images adopts the following conditions:
the parameters of the search—image shape and colour.
the images for the search:
   image 1: blue square,
   image 2: blue triangle,
   image 3: red circle,
   image 4: green circle,
the rules for calculating the shape descriptor:
   if there is a square in the image, the shape descriptor=1;
   if there is a triangle in the image, the shape descriptor=2;
   if there is a circle in the image, the shape descriptor=3;
the rules for calculation of the colour descriptor:
   if the image is in blue, the colour descriptor=1;
   if the image is in red, the colour descriptor=2;
   if the image is in green, the colour descriptor=3;
the rules for calculating the images descriptors difference: Difference=d₁−d₂, where the Difference is the result of the descriptor difference, d1 is the value of the descriptor of one of the parameters of the first image; d₂ is the value of the descriptor of the same parameter of the second image. If the result of the difference is a negative number, then the images with the greatest difference are considered the most similar images. If the result of the difference is a positive number, then the images with the smallest difference are considered the most similar images.

According to the present invention, the specialist performs a search for visually similar images in the following way:
1. computing of the images descriptors. In this case, the descriptors of the images are as follows:
   a. image 1: shape descriptor=1, colour descriptor=1;
   b. image 2: shape descriptor=2, colour descriptor=1;
   c. image 3: shape descriptor=3, colour descriptor=2;
   d. image 4: shape descriptor=3, colour descriptor=3;
2. computing the difference between corresponding descriptors of the images and saving the computed difference on paper. The result of the descriptor difference computation is as follows:
   a. the difference in the shape descriptors of images 1 and 2: Difference=d₁−d₂=1−2=−1;
   b. the difference in the colour descriptors of images 1 and 2: Difference=d₁−d₂=1−1=0;
   c. the difference in the shape descriptors of images 1 and 3: Difference=d₁−d₂=1−3=−2;
   d. the difference in the colour descriptors of images 1 and 3: Difference=d₁−d₂=1−2=−1;
   e. the difference in the shape descriptors of images 1 and 4: Difference=d₁−d₂=1−3=−2;
   f. the difference in the colour descriptors of images 1 and 4: Difference=d₁−d₂=1−3=−2;
   g. the difference in the shape descriptors of images 2 and 3: Difference=d₁−d₂=2−3=−1;
   h. the difference in the colour descriptors of images 2 and 3: Difference=d₁−d₂=1−2=−1;
   i. the difference in the shape descriptors of images 2 and 4: Difference=d₁−d₂=2−3=−1;
   j. the difference in the colour descriptors of images 2 and 4: Difference=d₁−d₂=1−3=−2;
   k. the difference in the shape descriptors of image 3 and 4: Difference=d₁−d₂=3−3=0;
   l. the difference in the colour descriptors of images 3 and 4: Difference=d₁−d₂=2−3=−1.
3. The customer of the search chooses image 3 and sends an oral request with identifier “image 3” to the specialist. It should be noted that the customer can choose only one of four images that have had descriptors and differences of the descriptors computed.
4. The specialist chooses from the list of computed results of the descriptor difference only those values which correspond to image 3. Next, the specialist sorts the results according to the rules and shows the result in the following way: “image 4, image 2, and image 1”. Image 4 is the most similar to image 3, according to the present invention, because images 3 and 4 have the smallest difference between the same descriptors (Difference in the shape descriptors of images 3 and 4 is equal to zero, which is the lowest value compared to the results of the difference in descriptors of images 3 and 1, 3 and 2), which means that image 3 and image 4 are the most similar compared to images 1 and 2.

In another embodiment, the invention can be implemented as a system which works under the rules, mentioned in the first embodiment of the present invention, mentioned above, and comprising the following elements:
a processor;
a hard disk with the program code and files with the images mentioned in the first embodiment of the present invention;
a display.

The program code comprises commands which, when executed by the processor, make the system perform a search for visually similar images according to the present invention. According to the present invention, the system works as follows:
the system loads the program code executed by the processor, which computes the images descriptors on the hard disk. The result of the computation is the same as the result described in the first step of the first embodiment;
the system loads the program code executed by the processor, which computes the difference of the images descriptors and saves the results to the hard disk. The computed result of the difference in the images descriptors is the same as the result described in the second step of the first embodiment;
the system loads the program code executed by the processor, which obtains the user's request with the image identifier, which is represented by the character “3”;
the system loads the program code executed by the processor, which displays the result in the same way described in the fourth step of the first embodiment.

In another embodiment, the invention can be used for searching visually similar goods in e-commerce web sites. According to the embodiment, the system works according to the rules stated in the first embodiment of the present invention, and comprises the following elements:
a server running an online shopping site, and comprising:
   a set of web-pages and databases with the images mentioned in the first embodiment;
   a software product, which implements the present invention;
   a processor.
a computer used by the user to connect to online shopping site. The computer comprises:
   a processor;
   a hard disk;
   a display;
   a network card to establish a network connection with the server.

According to the present invention, the system works as follows:
the server computes the images descriptors stored in the databases. The result of this computation is the same as the result described in the first step of the first embodiment;
the server computes the difference of the images descriptors and saves the results onto one or more databases. The computed result of the difference of the images descriptors is the same as the result described in the second step of the first embodiment;
the user connects to the server and sends the request with the image identifier, which is represented by the character “3”, to the server;
the server performs a search and sorts the computed results of the difference of descriptors corresponding to image 3, and displays the computed result of the descriptor difference on the user's display as a sequence of images, corresponding to images 4, 2, 1.

The foregoing description, for purposes of explanation, has been described with reference to specific embodiments. However, these are for illustration purpose only and are not intended to be exhaustive or to limit the invention to the precise forms disclosed.

What is claimed is:

1. A method of searching for visually similar images comprising:
a. computation of images descriptors stored on data storage media;
b. computation of the difference of images descriptors and storing the computed results on data storage media;
c. receiving a user's request, comprising an image identifier;
d. displaying the computed results of the difference of the descriptors corresponding to the image, the identifier of which was obtained from the user.

2. The method of claim 1, wherein the image descriptor is represented by a number.

3. The method of claim 1, wherein the computed results of the difference of images descriptors are stored in the database.

4. The method of claim 1, wherein digital media is used to store data.

5. The method of claim 1, wherein paper media is used to store data.

6. The method of claim 1, wherein the image identifier is a sequence number of the image.

7. The method of claim 1, wherein the image identifier is a title of the image.

8. The method of claim 1, wherein the identifier is a descriptor of the image.

9. The method of claim 1, wherein the computed results of the difference of images descriptors are represented as a list.

10. The method of claim 1, wherein the computed results of the difference of images descriptors are represented as a two-dimensional matrix.

11. A memory block, comprising a software product which implements a search of visually similar images, comprising:
a. a computer code for computation of the images descriptors;
b. a computer code for computation of the difference of the images descriptors and for storing the results on the memory block;
c. a computer code for obtaining a request from the user comprising an image identifier;
d. a computer code for displaying the computed results of the difference of descriptors which correspond to the image, the identifier of which was obtained from the user.

12. The memory block of claim 11, wherein the computed results of the difference of the images descriptors are stored in the database.

13. The memory block of claim 11, wherein the image identifier is a sequence number of the image.

14. The memory block of claim 11, wherein the image identifier is a title of the image.

15. The memory block of claim 11, wherein the image identifier is a descriptor of the image.

16. A device for searching for visually similar images comprising:
a. a processor;
b. a device for displaying data;
c. a device for storing data, comprising not less than one image;
d. a memory block functionally connected to the processor and comprising a computer code which, when executed by the processor, makes the device to perform searching for visually similar images:
i. compute the images descriptors stored on the device for storing data;
ii. compute the difference of the images descriptors and store the computed results on the device for storing data;
iii. obtain the user's request, comprising an image identifier;
iv. display the computed results of the difference of the descriptors which correspond to the image, the identifier of which was obtained from the user, on the device for displaying data.

17. The device of claim 16, wherein the device additionally comprises a database, and the computed results of the difference of the images descriptors are stored in the database.

18. The device of claim 16, wherein the identifier of the image is a sequence number of the image.

19. The device of claim 16, wherein the identifier of the image is a title of the image.

20. The device of claim 16, wherein the image identifier is a descriptor of the image.

21. A non-transitory computer useable recording medium having computer executable program logic stored thereon for executing on a processor, the program logic comprising computer program code for implementing the steps of claims 1-10.
